(19) United States
(12) Patent Application Publication
(10) Pub. No.: US 2006/0212517 A1
(43) Pub. Date: Sep. 21, 2006

(54) Method, system, and program product for maintaining synchronization among replicated applications using externality forwarding

(75) Inventors: Steven L. Rohall, Winchester, MA (US); John F. Patterson, Carlisle, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/080,148

(22) Filed: Mar. 15, 2005

(51) Int. Cl. G06F 15/16

(52) U.S. Cl. 709/205

(57) ABSTRACT

The present invention provides a method, system, and computer program product for maintaining synchronization among replicated applications. The method comprises: detecting an externality in an application on a moderator and making an external call associated with the externality; and forwarding results of the external call to a replica of the application on a collaborator.

### BACKGROUND OF THE INVENTION

1. Field of the Invention

The present invention generally relates to computer systems. More particularly, the present invention provides a method, system, and computer program product for maintaining synchronization among replicated applications in a collaborative environment using externality forwarding.

2. Related Art

Today, the choices for the synchronous sharing of applications are limited. A few applications, such as multi-user games, are developed with integrated collaborative features. The vast majority of end-user applications, however, are written as single-user applications. Collaborative application features are difficult to write and are not often high on the list of development priorities. Users who may be motivated to add collaborative features to an application often lack the resources (e.g., the source code) to accomplish this task. To share applications, users have had to resort to “screen-scraping” techniques using tools such as IBM Lotus Sametime and Microsoft NetMeeting. These tools track changes to a computer's screen buffer and transmit the changes as bitmaps to the other collaborators. This is both CPU- and network-intensive, limiting this technique's utility.

In replicated application sharing, separate copies of a single-user application run on each collaborator's computer. Events (e.g., keystrokes) from one copy of the application are broadcast to the other copies of the application where they are processed as if they had been generated locally, allowing the distributed applications to stay synchronized.

Collaborative use of replicated, single-user applications has long been a dream of Computer Supported Cooperative Work (CSCW) practitioners. If such a system were available, then many of the single-user applications available today could be repurposed as collaborative tools. Not only would people be able to collaborate, they would be able to collaborate with the applications to which they are accustomed.

On the face of it, this idea is simple. If all of the collaborators have a copy of the single-user application, then one user can “drive” all the application replicas (this user is referred to as the “moderator” and is said to have the “floor” when interacting with the application). Underlying this idea is the notion that, if the same sequence of events (e.g., user input) is sent to replicated instances of the application, then the application state will be manipulated and modified in the same manner in each of the application replicas and each collaborator will see the same result. This can be seen graphically in the replicated application environment 10 illustrated in FIG. 1. This approach is much more network-efficient than screen scraping systems, since the bandwidth of the input events is small compared to the application output which gets displayed to the user.

FIG. 1 shows two collaborators 12, 14 (although there could be any number of collaborators); the collaborator 12 on the left is the moderator (hereafter referred to a “moderator 12”) interacting with application 16, while the collaborator 14 on the right is observing the actions of the moderator 12. When the moderator 12 interacts with the application 16, an input event, labeled eₓ, is sent to the controller 18 for interpretation. Application logic will cause some sequence of operations as a result, as indicated by the solid arrows 20. The processing will wind through the model 22 and the view 24 of the application 16 and eventually produce some output, oₓ.

In replicated application sharing, the input event eₓ is caught and transmitted to the other collaborators (collaborator 14 in this example), as indicated by the dotted arrow 26 in FIG. 1. The input event eₓ is then interpreted by the applications 16 of the other collaborators. Assuming that the applications 16 were in the same initial state, the same processing flow occurs and the same output oₓ is produced.

There have been numerous attempts to build replicated application sharing systems. For example, MMConf, Dialogo, and the first version of Rapport provided shared windowing systems that captured windowing system input events and transmitted those events to application replicas. Unfortunately, these systems ran into synchronization problems where the application replicas would display different output for the same input event. This problem arose, in part, because it was incorrectly assumed that state changes within the replicated applications were deterministic (i.e., starting from the same initial state, the application will generate the same sequence of outputs given the same sequence of inputs).

The assumption of deterministic state changes fails to take into account the different operating environments of each replicated application. When external resources are accessed that are not located within the application model itself (e.g., default font color, current system time, the next random number from a random number generator, a preference file, etc.), a different result may be returned to each replicated application. Subsequent processing in each replicated application then follows a different path and produces different results—the applications are no longer synchronized. These environmental problems are called “externalities.” More specifically, an externality is an input (other than the user) or an output (other than the display) that is external to the application itself.

This situation is depicted in FIG. 2, which shows a replicated application environment 10 similar to that described above with regard to FIG. 1. In this example, however, the application logic consults something in the environment 28 outside of the application 16 as indicated by the arrows 30. This could include accessing a file on a local file system, making a system call to retrieve the current system time, etc. Since the operating environments of the applications 16 are not identical, the environmental access returns a different result to each application 16. Subsequent processing follows a different path through the two applications 16. As a result, while the moderator 12 sees output oₓ, another collaborator (e.g., collaborator 14) sees output o_{y}. The different path followed in the application 16 by the collaborator 14 is indicted by the dashed arrows 32.

In short, although MMConf, Dialogo, and the first version of Rapport succeeded in replicating the application, they failed to replicate the application's operating environment. Indeed, since they only intercepted window system events, they could only handle externalities associated with the window system itself (e.g., referencing a color map or a font); they could not handle externalities associated with the larger operating environment (e.g., accessing a preferences file).

One key to fixing the problem is environmental replication—replicating environmental state across the replicated applications. Strict environmental replication is not possible since every computer is unique. Rather, it is important to try to minimize the likelihood of externalities and, when possible, to detect and correct the externalities which cannot be prevented. One approach to minimizing externalities is to ensure that there is a common operating environment for all of the collaborators. Java, for example, simplifies the process of replicating applications since it defines a virtual machine which provides abstractions for many elements in the operating environment. However, with different versions of the Java virtual machine and many core Java methods implemented using native operating systems calls, Java by itself does not solve the problem. A way to share the results of externalities is also needed.

Flexible JAMM improves upon the earlier window-sharing systems by exploiting properties of the Java language to dynamically replace single-user components with specially-written multi-user counterparts. This proves more successful than window sharing systems in that it is able to handle more externalities. In particular, in Flexible JAMM, any Java object implemented using native calls to the operating systems is treated as an externality. Flexible JAMM replaces calls to these objects with calls to a proxy and wraps the actual object with a small server. The proxy object uses Java Remote Method Invocation (RMI) to access the server and retrieve the necessary data. In this way, all collaborators see the same result to the externality. This is shown in FIG. 3 (note that only the environment 28 for the moderator 12 is shown). Flexible JAMM dynamically replaces single-user Java classes with multi-user ones. Some of the classes that are replaced are those known to cause externalities. When Flexible JAMM replaces one of these classes, it first creates a small server 34 to control access to the environmental state. It then replaces the class with a small proxy which implements the same interface. This proxy uses Java RMI to communicate with the server 34 controlling access to the state. Since both the remote collaborators and the local moderator 12 access (e.g., as indicated by arrows 36) the same environmental state via the server 34, all see the same result and the applications 16 remain synchronized.

Unfortunately, there are limitations to the Flexible JAMM approach. First, a proxied externality adds a centralized server to an otherwise distributed, replicated architecture. This has disadvantages of decreased fault tolerance (e.g., it creates a single point of failure in an otherwise peer-to-peer system) and increased latencies (e.g., additional communication overhead/delay). Second, care must be taken with environmental calls which can produce different results each time they are invoked (e.g., calls to the system time or to a random number generator). Third, there are additional security concerns with having multiple servers running which provide access to pieces of the operating environment. Fourth, the replacement of Java objects at run time itself has several limitations (e.g., sub-classes of replaceable classes cannot, in general, be replaced). Finally, since it used a customized Java class loader to detect when one of the “dangerous” classes is being loaded, it doesn't transfer well to a system which already has a custom class loader of its own.

### SUMMARY OF THE INVENTION

In general, the present invention provides a method, system, and computer program product for maintaining synchronization among replicated applications in a collaborative environment using externality forwarding. In particular, rather than relying on a client-server approach to distributing externalities, such as that employed by Flexible JAMM, the present invention forwards the results of externalities to the replicated applications, eliminating the network round trip and reducing network traffic. Further, there is no longer a single point of failure as in Flexible JAMM, and there is more room for recovery should a failure occur in the replicated application environment.

A first aspect of the present invention is directed to a method for maintaining synchronization among replicated applications, comprising: detecting an externality in an application on a moderator and making an external call associated with the externality; and forwarding results of the external call to a replica of the application on a collaborator.

A second aspect of the present invention is directed to a system for maintaining synchronization among replicated applications, comprising: a system for detecting an externality in an application on a moderator and making an external call associated with the externality; and a system for forwarding results of the external call to a replica of the application on a collaborator.

A third aspect of the present invention is directed to a program product stored on a computer readable medium for maintaining synchronization among replicated applications, the computer readable medium comprising program code for performing the following steps: detecting an externality in an application on a moderator and making an external call associated with the externality; and forwarding results of the external call to a replica of the application on a collaborator.

A fourth aspect of the present invention provides a system for maintaining synchronization among replicated applications, comprising: a computer infrastructure being operable to: detect an externality in an application on a moderator and make an external call associated with the externality; and forward results of the external call to a replica of the application on a collaborator.

A fifth aspect of the present invention provides computer software embodied in a propagated signal for maintaining synchronization among replicated applications, the computer software comprising instructions to cause a computer system to perform the following functions: detect an externality in an application on a moderator and make an external call associated with the externality; and forward results of the external call to a replica of the application on a collaborator.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative replicated application environment.

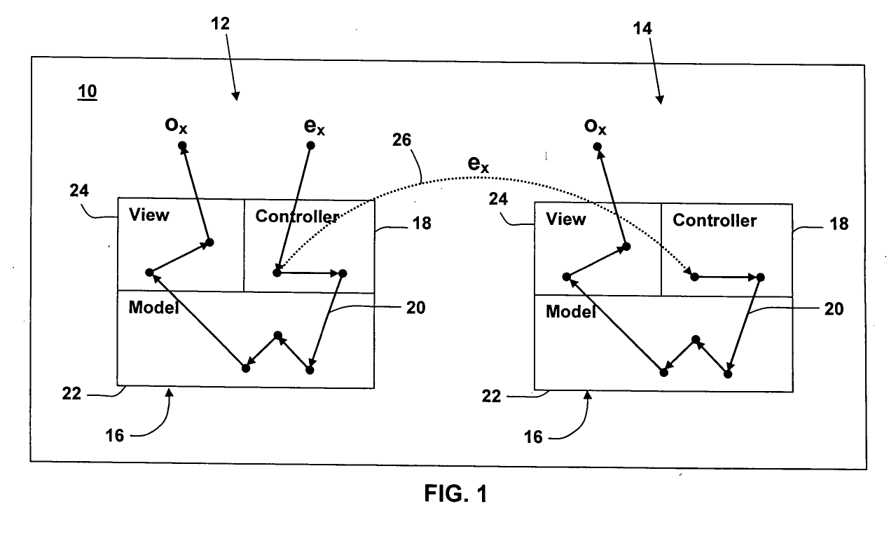

FIG. 2 depicts the effect of externalities on the processing flow in the replicated application environment of FIG. 1.

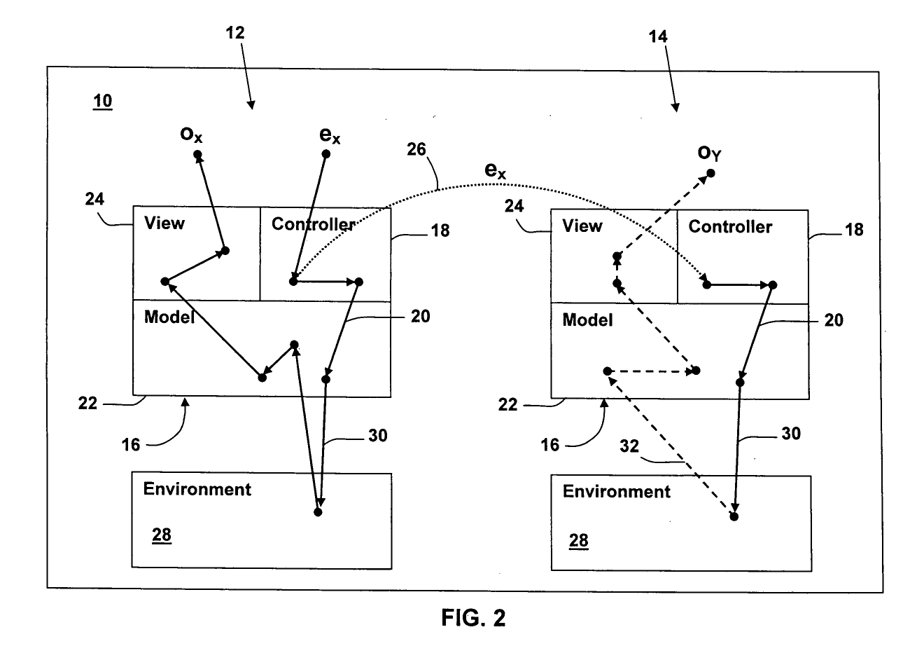

FIG. 3 depicts the approach used by Flexible JAMM to reduce the problems caused by externalities.

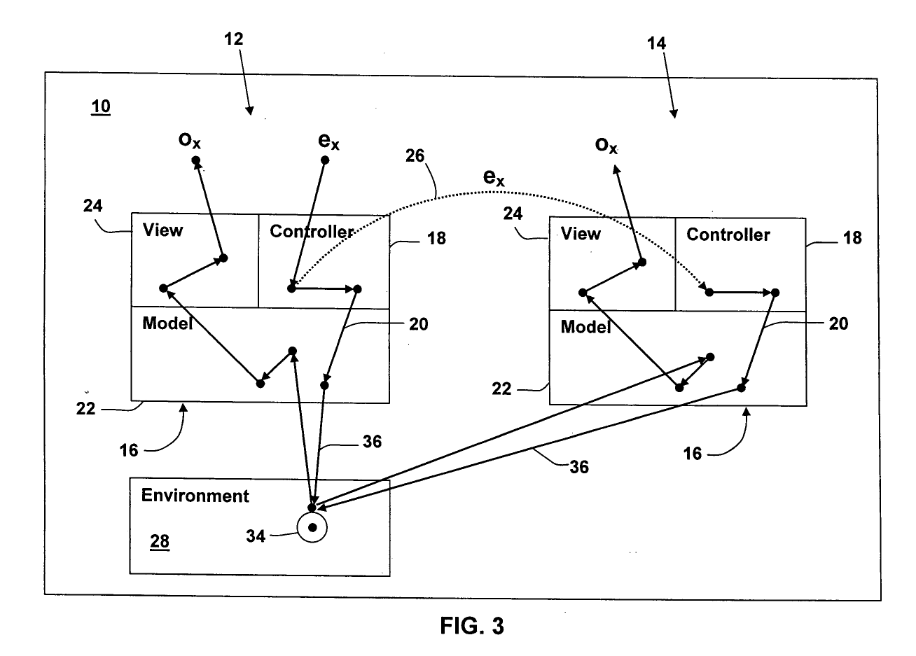

FIG. 4 depicts an illustrative system for maintaining synchronization among replicated applications in a collaborative environment using externality forwarding in accordance with an embodiment of the present invention.

FIG. 5 depicts a flow diagram of a method in accordance with an embodiment of the present invention.

FIG. 6 depicts an illustrative computer system for implementing the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and computer program product for maintaining synchronization among replicated applications. In particular, rather than relying on a client-server approach to distributing externalities, such as that employed by Flexible JAMM, the present invention forwards the results of externalities to the replicated applications, eliminating the network round trip and reducing network traffic.

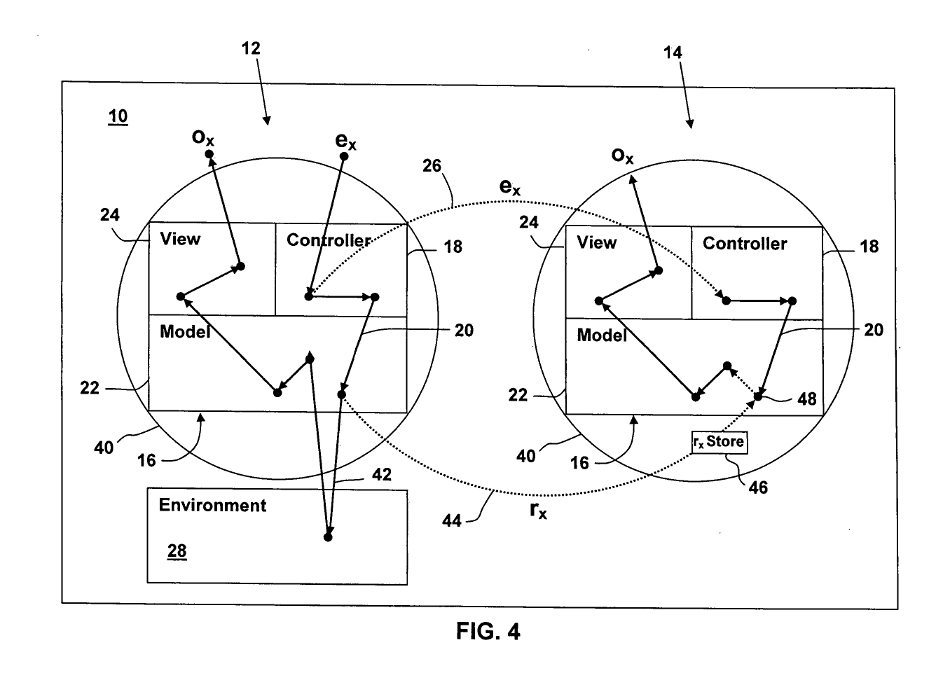

In accordance with the present invention, as depicted in FIG. 4, a boundary 40 is created around the application 16 and it is assumed that operations inside the boundary 40 are deterministic. That is, copies of the same application in the same initial state will respond identically to the same input. Operations which cross the boundary 40 (e.g., file system accesses) are considered externalities.

When an externality is detected in the application 16 of the moderator 12, the external call 42 is allowed to occur. The results rₓ returned by the external call are then packaged and forwarded (i.e., multi-cast) as indicated by arrow 44 to the other collaborators (e.g., collaborator 14) in the replicated application environment 10, where the results rₓ are stored by the applications 16 (e.g., in a rₓ store 46) until needed.

When the application 16 of the collaborator 14 gets to the point 48 of the externality, it first checks the rₓ store 46 to see if it has already received the results rₓ from the moderator 12. If so, processing of the application 16 continues using the results rₓ. If the results rₓ have not been received, the application 16 must wait until the results rₓ becomes available from the moderator 12. Once the results rₓ have been received from the moderator 12, the application 16 is able to proceed and produce the correct output. In this manner, the same results rₓ for each externality are used by all of the applications 16 in the replicated application environment 10. This ensures that each application 16 will produce the same result oₓ in response to a given event eₓ.

In one approach to externality forwarding in accordance with the present invention, aspect-oriented programming (AOP) techniques are used to monitor the application 16 of the moderator 12 for externalities. This allows the application 16 to be monitored without its knowledge. The use of AOP is an improvement over the dynamic class replacement used in Flexible JAMM, but is only one possible technique for detecting and managing external application accesses (i.e., externalities) in accordance with the present invention.

One of the recent advances in software engineering has been the development of AOP. “Aspects” are special objects which define rules for actions occurring before, after, and within code. While object-oriented programming is a methodology for software modularization, separating specific pieces of application functionality into objects, AOP extends this separation further by effectively modularizing calls that are repeated across disparate objects.

The canonical example for AOP is application logging. Objects in an application make calls to a logging object throughout their methods. This results in logging code being repeated and mixed with core functionality. The AOP approach replaces all of the logging calls with a logging aspect which defines rules to ensure logging occurs at the appropriate time and in the appropriate objects. The objects themselves have no knowledge they are being logged, and all logging functionality is centralized in a single aspect.

In the present invention, AOP is used for hooking the state-changing events of single-user applications in order to make them multi-user. Perhaps the biggest appeal of AOP for collaborative applications is that the applications being made collaborative do not need to be modified or even recompiled. Other than knowing the places to hook them (called “pointcuts” in AOP terminology), very little information about the applications is needed to make them collaborative. AOP is also more flexible than the dynamic class replacement used in Flexible JAMM. First, an AOP approach is not limited to sharing only events from “well behaved” toolkits such as Java Swing. Since any method can be hooked, events can be captured from any library, even those without a clean model-view separation. Second, a subclass of a shared object will inherit the sharing of the superclass provided by AOP. This was a problem with Flexible JAMM.

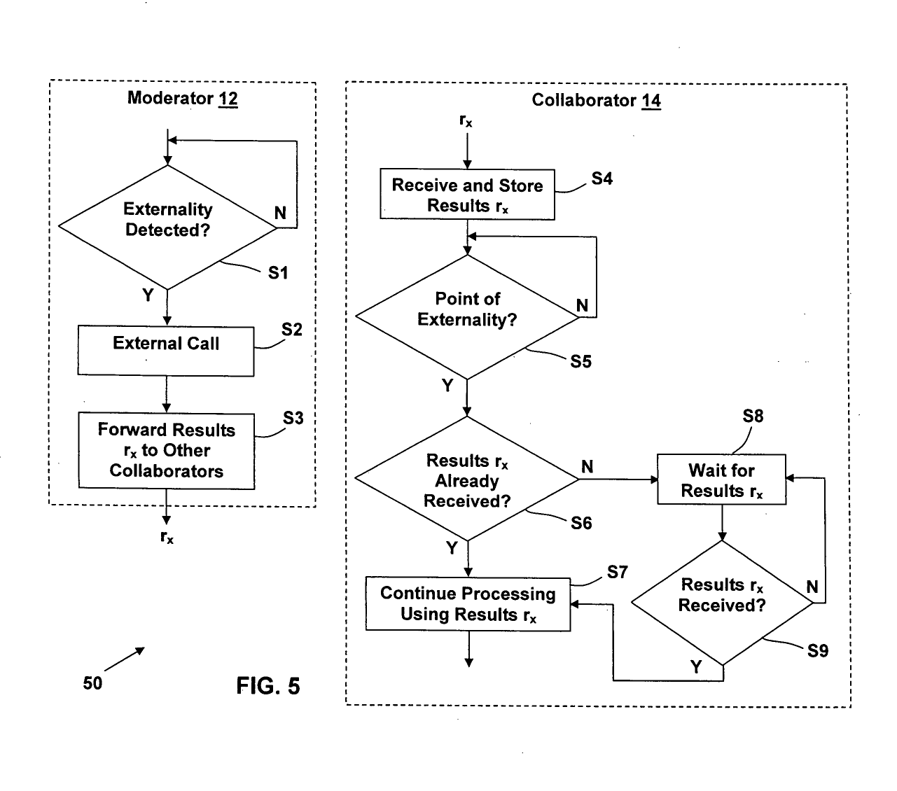

A flow diagram 50 of a method in accordance with an embodiment of the present invention is depicted in FIG. 5. In step S1, an externality is detected in the application 16 of the moderator 12. In response, in step S2, the external call 42 is allowed to occur. In step S3, the results rₓ returned by the external call 42 are packaged and forwarded to the other collaborators (e.g., collaborator 14) in the replicated application environment 10. In step S4, the results rₓ are stored by the applications 16 (e.g., in a rₓ store 46) until needed.

When the application 16 of the collaborator 14 gets to the point 48 of the externality (step S5), it first checks the rₓ store 46 in step S6 to see if it has already received the results rₓ from the moderator 12. If so, processing of the application 16 continues in step S7 using the results rₓ. If the results rₓ have not already been received and stored, the application 16 waits in steps S8 and S9 until the results rₓ are received from the moderator 12. Once the results rₓ have become available from the moderator 12, the application 16 is able to proceed with its processing and flow passes to step S7.

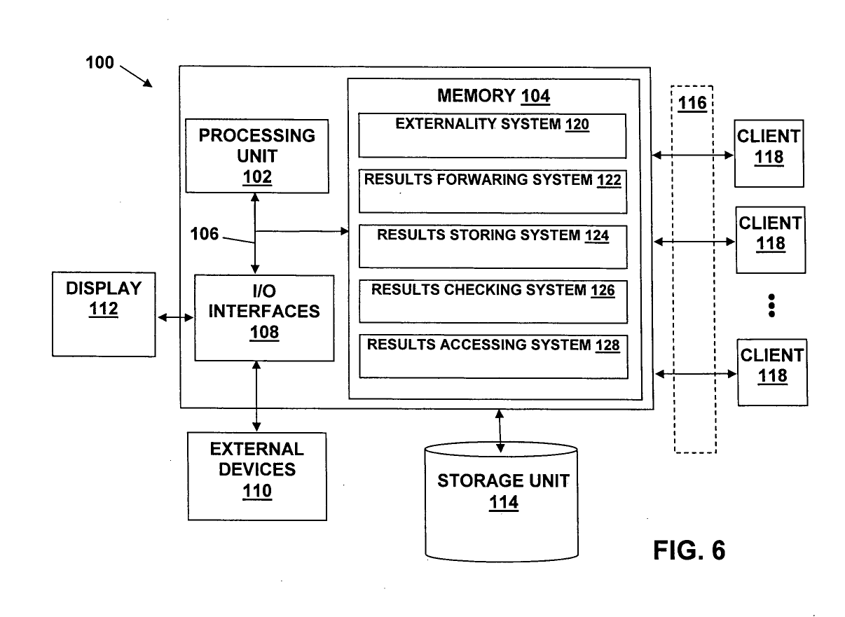

A computer system 100 for maintaining synchronization among replicated applications in accordance with an embodiment of the present invention is depicted in FIG. 6. Computer system 100 generally includes a processing unit 102, memory 104, bus 106, input/output (I/O) interface(s) 108, and external devices/resource(s) 110. Processing unit 102 may comprise a single processing unit, or may be distributed across one or more processing units in one or more locations. Memory 104 may comprise any known type of data storage and/or transmission media, including magnetic media, optical media, random access memory (RAM), read-only memory (ROM), etc. Moreover, similar to processing unit 102, memory 104 may reside at a single physical location, comprising one or more types of data storage, or be distributed across a plurality of physical systems in various forms. In this example, computer system 100 may be used as a moderator or collaborator in a replicated application environment.

I/O interface(s) 108 may comprise any system for exchanging information to/from an external source. External devices/resource(s) 110 may comprise any known type of external device, including speakers, a handheld device, keyboard, mouse, voice recognition system, speech output system, printer, monitor/display (e.g., display 112), facsimile, pager, etc.

Bus 106 provides a communication link between each of the components in computer system 100, and likewise may comprise any known type of transmission link, including electrical, optical, wireless, etc. In addition, although not shown, additional components, such as cache memory, communication systems, system software, etc., may be incorporated into computer system 100.

Data, applications, etc., (e.g., application 16, results rₓ, etc.) used in the practice of the present invention can be stored locally to computer system 100, for example, in storage unit/database 114, and/or may be provided to computer system 100 over a network 116. Storage unit/database 114 can be any system capable of providing storage for data and information under the present invention. As such, storage unit/database 114 may reside at a single physical location, comprising one or more types of data storage, or may be distributed across a plurality of physical systems in various forms. In another embodiment, storage unit/database 114 may be distributed across, for example, a local area network (LAN), wide area network (WAN) or a storage area network (SAN) (not shown).

Network 116 is intended to represent any type of network over which data can be transmitted. For example, network 116 can include the Internet, a wide area network (WAN), a local area network (LAN), a virtual private network (VPN), a WiFi network, or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server. One or more client devices 118, each acting as a moderator or collaborator in a replicated application environment, may be connected to computer system 100 via network 116. Each client device 118 comprises components similar to those described above with regard to computer system 100.

Shown in memory 104 as a computer program product is an externality system 120 for detecting externalities in an application and for performing external calls in response thereto, and a results forwarding system 122 for forwarding the results rₓ of the external calls to each collaborator (e.g., client devices 118) in a replicated application environment, in accordance with the present invention (this assumes that computer system 100 is serving as the moderator).

Also shown in memory 104 is a results storing system 124 for storing results rₓ forwarded to computer system 100 from a moderator, a results checking system 126 for determining if the results rₓ for a given externality have already been received and stored, and a results accessing system 128 for accessing the stored results rₓ if they are available and for providing the results to the associated application (this assumes that computer system 100 is operating as a collaborator). If the results rₓ corresponding to an externality have not yet been received, the results checking system 126 waits for the results rₓ to arrive and then provides the results rₓ to the associated application.

It should be appreciated that the teachings of the present invention can be offered as a business method on a subscription or fee basis. For example, one or more components of the present invention could be created, maintained, supported, and/or deployed by a service provider that offers the functions described herein for customers. That is, a service provider could be used to maintain synchronization among replicated applications, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for maintaining synchronization among replicated applications, comprising:
detecting an externality in an application on a moderator and making an external call associated with the externality; and
forwarding results of the external call to a replica of the application on a collaborator.

2. The method of claim 1, further comprising:
storing the results of the external call on the collaborator until needed by the replica of the application.

3. The method of claim 2, further comprising:
determining a point of externality in the replica of the application on the collaborator; and
determining if the results of an external call corresponding to the externality have been stored on the collaborator.

4. The method of claim 3, further comprising:
accessing the results of the external call if the results have been stored on the collaborator; and
continuing processing of the application using the accessed results.

5. The method of claim 3, further comprising:
waiting for the results of the external call from the moderator if the results have not yet been received by the collaborator; and
continuing processing of the application upon receipt of the results.

6. The method of claim 1, wherein the results of the external call are forwarded to the replica of the application on a plurality of collaborators.

7. The method of claim 1, further comprising:
monitoring the application on the moderator for externalities without the application's knowledge.

8. Deploying an application for maintaining synchronization among replicated applications, comprising:
providing a computer infrastructure being operable to perform the method of claim 1.

9. Computer software embodied in a propagated signal for maintaining synchronization among replicated applications, the computer software comprising instructions to cause a computer system to perform the method of claim 1.

10. A system for maintaining synchronization among replicated applications, comprising:
a system for detecting an externality in an application on a moderator and making an external call associated with the externality; and
a system for forwarding results of the external call to a replica of the application on a collaborator.

11. The system of claim 10, further comprising:
a system for storing the results of the external call on the collaborator until needed by the replica of the application.

12. The system of claim 11, further comprising:
a system for determining a point of externality in the replica of the application on the collaborator; and
a system for determining if the results of an external call corresponding to the externality have been stored on the collaborator.

13. The system of claim 12, further comprising:
a system for accessing the results of the external call if the results have been stored on the collaborator; and
a system for continuing processing of the application using the accessed results.

14. The system of claim 12, further comprising:
a system for waiting for the results of the external call from the moderator if the results have not yet been received by the collaborator; and
a system for continuing processing of the application upon receipt of the results.

15. The system of claim 10, wherein the results of the external call are forwarded to the replica of the application on a plurality of collaborators.

16. The system of claim 10, further comprising:
a system for monitoring the application on the moderator for externalities without the application's knowledge.

17. A program product stored on a computer readable medium for maintaining synchronization among replicated applications, the computer readable medium comprising program code for performing the following steps:
detecting an externality in an application on a moderator and making an external call associated with the externality; and
forwarding results of the external call to a replica of the application on a collaborator.

18. The program product of claim 17, further comprising program code for performing the following step:
storing the results of the external call on the collaborator until needed by the replica of the application.

19. The program product of claim 18, further comprising program code for performing the following steps:
determining a point of externality in the replica of the application on the collaborator; and
determining if the results of an external call corresponding to the externality have been stored on the collaborator.

20. The program product of claim 19, further comprising program code for performing the following steps:
accessing the results of the external call if the results have been stored on the collaborator; and
continuing processing of the application using the accessed results.

21. The program product of claim 19, further comprising program code for performing the following steps:
waiting for the results of the external call from the moderator if the results have not yet been received by the collaborator; and
continuing processing of the application upon receipt of the results.

22. The program product of claim 17, wherein the results of the external call are forwarded to the replica of the application on a plurality of collaborators.

23. The program product of claim 17, further comprising program code for performing the following step:
monitoring the application on the moderator for externalities without the application's knowledge.
